(19) United States
(12) Patent Application Publication
(10) Pub. No.: US 2005/0134891 A1
(43) Pub. Date: Jun. 23, 2005

(54) Image processing apparatus

(76) Inventor: Koji Ishizaki, Tokyo (JP)

Correspondence Address: RABIN & Berdo, PC, 1101 14TH STREET, NW, SUITE 500, WASHINGTON, DC, 20005, US

(21) Appl. No.: 11/012,209

(22) Filed: Dec. 16, 2004

(30) Foreign Application Priority Data
Dec. 18, 2003 (JP) 2003-421195

(51) Int. Cl. G06F 15/00

(52) U.S. Cl. 358/1.13; 358/1.1

(57) ABSTRACT

It is an object of this invention to reduce useless printed material by enabling an operator to be informed of details of printing setting and to obtain his intended printing result upon displaying, after starting of the printing processing with an application, a dialog for confirming or changing the details of the printing setting, as well as to prevent any delay in the printing by continuing the printing when certain time passes without any input in a case of displaying of a confirmation dialog for the details of the printing setting. To achieve the above object, an image processing apparatus comprises a displaying unit for displaying, upon input of printing start instruction, information based on printing setting information, a timer for measuring time from the displaying start of the displaying unit, and a data converter for converting printing data into printing controlling data based on the printing setting information at a time when the timer reaches a prescribed amount, wherein an image is formed by transmitting the printing controlling data to an image forming unit.

### BACKGROUND OF THE INVENTION

1. Field of the Invention

This invention relates to an image processing apparatus.

2. Description of Related Art

Conventionally, with printers, when printing is executed with use of an application program, i.e., an application, such as a word processing program installed in a host apparatus such as, e.g., a personal computer, a printing setting dialog corresponding to a driver for the printer is to be displayed, to confirm or to change details of the printing setting, on a screen of a displaying apparatus on the host apparatus (ref., e.g., Japanese Patent Application Publication No. JA10-211751).

FIG. 2 is the first view showing a display example of printing instruction with an application; FIG. 3 is a view showing a display example of a printing dialog with the application; FIG. 4 is a view showing a display example of a printing setting dialog corresponding to a driver for a printer executing printing; and FIG. 5 is the second view showing a display example of printing instruction with the application.

Where the printing is executed with using a generally used application, the printing dialog such as shown in FIG. 3 is displayed in selecting a “print” menu from a “file” menu of the application displayed on the screen of the displaying apparatus on the host apparatus as shown in FIG. 2. In a case of selecting the printer executing printing from the printing dialog and further selecting, upon clicking, a “property” button as shown by M1 in FIG. 3 or a “detail setting” button not shown, the printing setting dialog corresponding to the driver for the printer executing printing is displayed as shown in FIG. 4. The operator, furthermore, confirms setting contents shown in the printing setting dialog, and if necessary, changes the setting, thereby closing the screen of the printing setting dialog corresponding to the driver for the printing upon clicking an “OK” button. Subsequently, in the screen of the printing dialog, when the operator carries out printing start instruction by clicking the “OK” button, the application starts a printing processing.

Even if the “file” menu or the “printing” menu is not selected, where displaying a printing icon at the toolbar as shown at M2 in FIG. 5, the application can also start the printing processing by the clicking of the printing icon without displaying the printing dialog.

There is, furthermore, a case where the printing processing can immediately start since the application for recognizing the document file is run upon dragging and dropping a document file as a printing object to the icon of the printer executing the printing in an aggregate folder of printer icons, referred to as a “printer” or a “printer and facsimile” folder, i.e., upon putting a pointer over the document file icon and moving a mouse with clicking the button, thereby releasing the button over the printer icon.

When starting the printing processing, the application draws, with use of a graphic function of an OS (Operating system), printing data to be printed. In that case, the operating system is to call the driver for the printer to transfer the printing data drawing of the application thereto. The driver for the printer, furthermore, converts, based on the printer driver's printing setting set with the application or on the standard printing setting, the printing data drawing of the application into a printing controlling code interpretable to the printer, thereby transmitting the printing controlling code to the printer. The printing is thus carried out.

With the aforementioned conventional printer, however, it is necessary to open the printing setting dialog corresponding to the driver for the printer by clicking the “property” or the “detail setting” button to change the details of the printing setting in executing the printing with displaying the printing dialog from the application, but a name specified as “property” is not a direct expression for meaning the details of the printing setting. Therefore, some operator exists, such as not recognizing that the details of the printing setting can be set upon clicking the “property” button. In that case, useful functions end up unutilized sufficiently.

This invention is aimed to solve the aforementioned conventional problems and to provide an image processing apparatus capable of notifying the operators who do not have adequate understanding about the displaying method of the details of the printing setting by displaying the dialog for confirming or changing the details of the printing setting after starting the printing processing with the application, and capable of reducing useless printed material by enabling the operator to obtain his intending printing results.

### SUMMARY OF THE INVENTION

To achieve the above, an image processing apparatus has a displaying unit for displaying, upon input of printing start instruction, information based on printing setting information; a timer for measuring time from the displaying start of the displaying unit; and a data converter for converting printing data into printing controlling data based on the printing setting information at a time when the timer reaches a prescribed amount, and forms an image by transmitting the printing controlling data to an image forming unit.

According to this invention, the image processing apparatus can notify an operator who does not recognizes a method for displaying details of the printing setting, about the detailed setting upon displaying a dialog for confirming or changing the details of the printing setting after a start of a printing processing with an application, and furthermore can reduce useless printed materials upon enabling the operator to obtain his intending printing results.

Additionally, in a case of displaying of a confirmation dialog for the printing setting details, when certain time passes without any input by the operator, the printing is automatically continued, so delay in the printing can be avoided.

### BRIEF DESCRIPTION OF THE DRAWINGS

FIG. 1 is a block diagram showing a composition of an image processing apparatus according to the first embodiment of this invention;

FIG. 2 is the first view showing a display example of printing instruction with an application;

FIG. 3 is a view showing a display example of a printing dialog with an application;

FIG. 4 is a view showing a display example of a printing setting dialog corresponding to a driver for a printer executing a printing;

FIG. 5 is the second view showing a display example of printing instruction with an application;

FIG. 6 is a view showing a display example of printing setting information according to the first embodiment of this invention;

FIG. 7 is a flow chart showing operation of a printer driver according to the first embodiment of this invention;

FIG. 8 is a flow chart showing a subroutine for a printing setting information displaying and changing processing with a timer according to the first embodiment of this invention;

FIG. 9 is a flow chart showing a subroutine for a timer processing according to the first embodiment of this invention;

FIG. 10 is a view showing a display view of printing setting information according to the second embodiment of this invention;

FIG. 11 is a flow chart showing a subroutine for processing a printing setting information displaying and changing processing with a timer according to the second embodiment of this invention;

FIG. 12 is the first view showing a display view of printing setting information according to the third embodiment of this invention;

FIG. 13 is the second view showing a display view of printing setting information according to the third embodiment of this invention;

FIG. 14 is a flow chart showing a subroutine for printing setting information displaying and changing processing with a timer according to the third embodiment of this invention;

FIG. 15 is a view showing a display view of printing setting information according to the fourth embodiment of this invention;

FIG. 16 is a flow chart showing operation of a printer driver according to the fourth embodiment of this invention;

FIG. 17 is a block diagram showing a composition of an image processing apparatus according to the fifth embodiment of this invention;

FIG. 18 is a view showing a display example of printing setting information according to the fifth embodiment of this invention; and

FIG. 19 is a flow chart showing operation of a printer driver according to the fifth embodiment of this invention.

### DETAILED DESCRIPTION OF PREFERRED EMBODIMENTS OF THE INVENTION

Hereinafter, preferred embodiments of this invention will be described in detail with reference to the drawings.

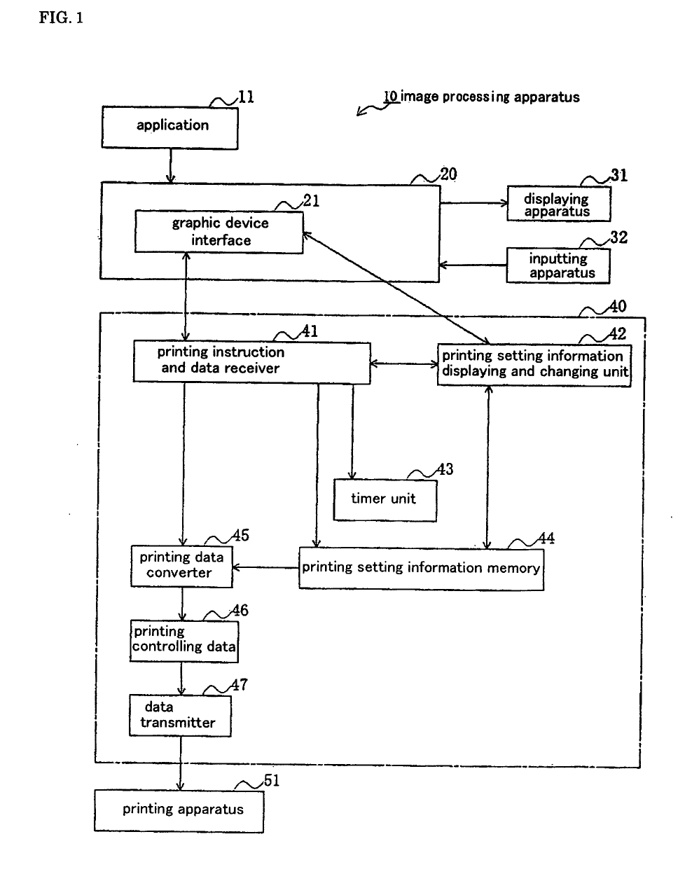

FIG. 1 is a block diagram showing a composition of an image processing apparatus according to the first embodiment of this invention.

In the figure, numeral 10 is an image processing apparatus having, from the view point to functions, an application 11, an operating system 20, a displaying unit, an inputting unit, a printer driver 40, and an image forming unit. Herein, the image processing apparatus 10 has, from the view point to hardware, for example: an operation means such as a CPU, a MPU or the like, e.g., a personal computer, a server, a workstation; a memory means such as a magnetic disk, a semiconductor memory, or the like; an input means such as a keyboard, a mouse, or the like; an displaying means such as a CRT, a liquid crystal display, or the like; a host apparatus serving as a computer having input/output interfaces, and a printing apparatus having image forming functions, such as a printer, a photocopier, a facsimile machine, or the like. In that case, the host apparatus and the printing apparatus can be composed as separated and independent to each other, so those apparatuses may be connected to be mutually communicable with a network such as, e.g., communication cable, a LAN (Local Area Network), a WAN (Wide Area Network), an intranet, or the Internet, or may be composed in a unified manner as being a single apparatus.

It is to be noted that the description herein is made, for convenience of explanation, as the image processing apparatus 10 is a kind of an image forming system composed of the host apparatus and the printing apparatus composed as mutually independent separated apparatuses. In that case, in Figures, an displaying apparatus 31 functions as the displaying unit; an inputting apparatus 32 functions as the inputting unit; and a printing apparatus 51 functions as the image forming unit. Additionally, the application 11, the operating system 20, the displaying apparatus 31, the inputting apparatus 31, the inputting apparatus 32, and the printer driver 40 are belonging to the host apparatus.

The application 11 is an application program for generating and printing a document to be printed, whereas the operating system 20 has a graphic device interface 21 for providing graphic drawings (hereinafter, referred to as “printing data drawing”) not depending on output used for printing of the document with the application 11. It is to be noted that the documents of the application 11 as well as information for carrying out printing start instruction for the document, or the like are displayed on the displaying apparatus 31, but data displayed on the displaying apparatus 31 are administrated with the operating system 20, and are displayed by a method for, e.g., displaying upon writing other information over a screen already displayed.

The data displayed on the displaying apparatus 31 may be in any format of a figure, a letter or character, an image or the like, but in this embodiment, those data are displayed by a method referred to as a GUI (Graphical User Interface). It is to be noted that the inputting apparatus 32 notifies a module about a demand from an operator with regard to waiting for the demand from the operator occurring during an execution process of the printing. Additionally, a printing method of the printing apparatus 51 may be any kind of the printing methods such as, e.g., an inkjet method, an electrophotostatic method or xerography method, and a thermal transfer method. It is to be noted that the operating system 20 administrates the application 11, the displaying apparatus 31, the inputting apparatus 32, and the printing apparatus 51.

The printer driver 40 has: a printing instruction and data receiver 41 for receiving the printing start instruction and the printing data drawing carried out via the graphic device interface 21, for printing the document with the application 11; a printing setting information displaying and changing unit 42 serving as a printing setting information changing inputting unit for displaying the printing setting information such as, e.g., a printed format of the printing data and for receiving a change from the operator; a timer unit 43 serving as a timer for measuring time in which the printing setting information displaying and changing unit 42 displays a current setting and carries out the displaying of the current setting after the application 11 carries out the printing start instruction for the document; a printing setting information memory 44 for memorizing the printing setting information such as, e.g., the printed format of the printing data of the application 11 received with the printing instruction and data receiver 41; a printing data converter 45 serving as a converter for converting based on the printing setting information memorized in the printing setting information memory 44, the printing data drawing of the application 11 received with the printing instruction and data receiver 41 into printing controlling data 46 depending on the printing apparatus 51; the converted printing controlling data 46; and a data transmitter 47 for transmitting the printing controlling data 46 to the printing apparatus 51.

It is to be noted that the printing setting information memorized in the printing setting memory 44 and used as a basis when the printing data converter 45 executes the conversion into the printing controlling data 46, is information for designating the printed format of the printing data, such as printing paper size, paper source, resolution, layout method, orientation, or the like.

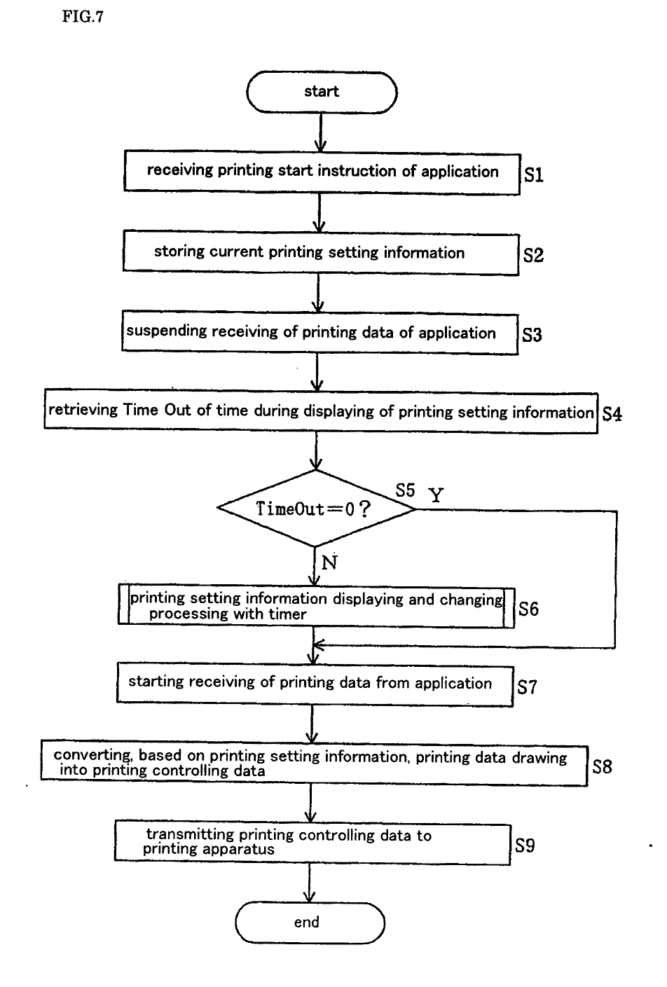

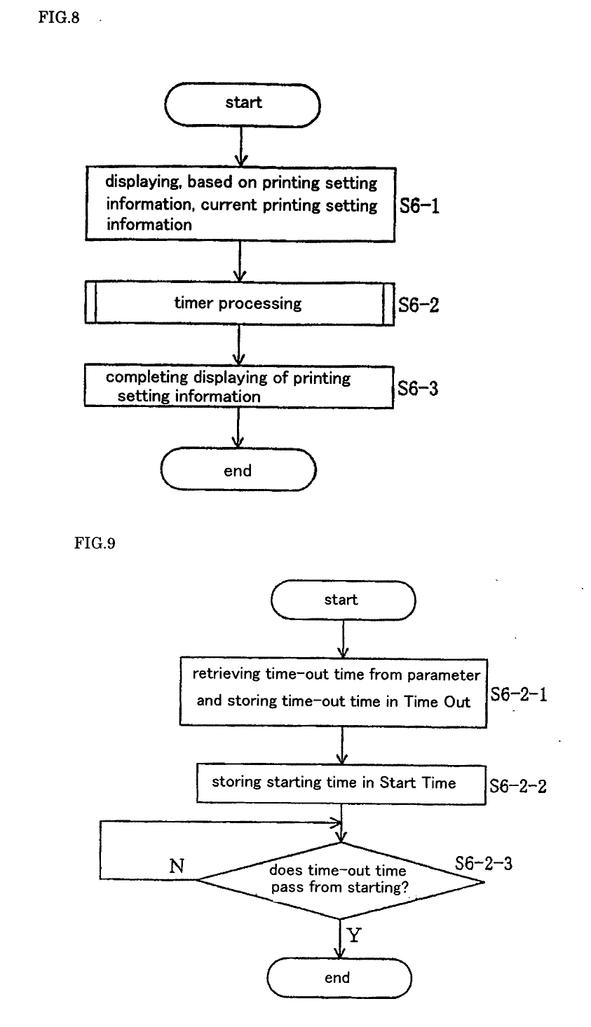

The image processing apparatus 10 thus constituted operates as follows. FIG. 6 is a view showing a display example of the printing setting information according to the first embodiment of this invention; FIG. 7 is a flow chart showing operation of the printer driver according to the first embodiment of this invention; FIG. 8 is a flow chart showing a subroutine for the printing setting information displaying and changing processing with the timer according to the first embodiment of this invention; and FIG. 9 is a flow chart showing a subroutine for the timer processing according to the first embodiment of this invention.

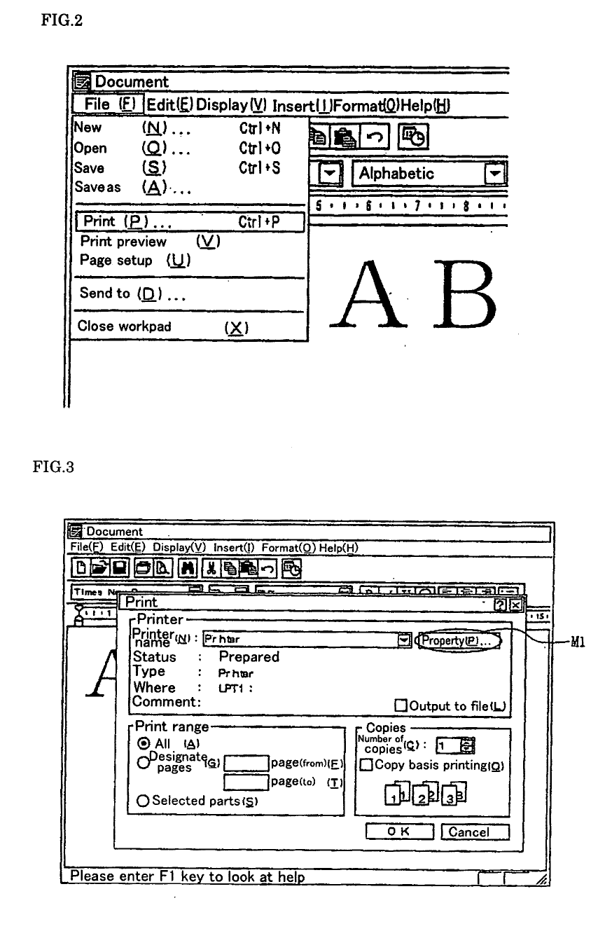

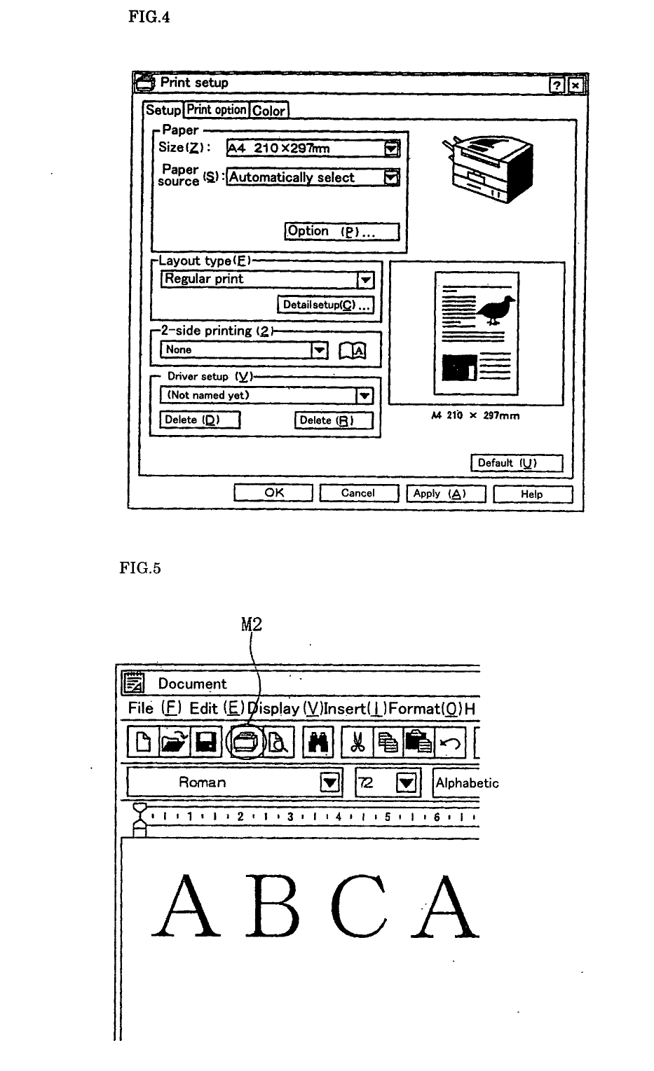

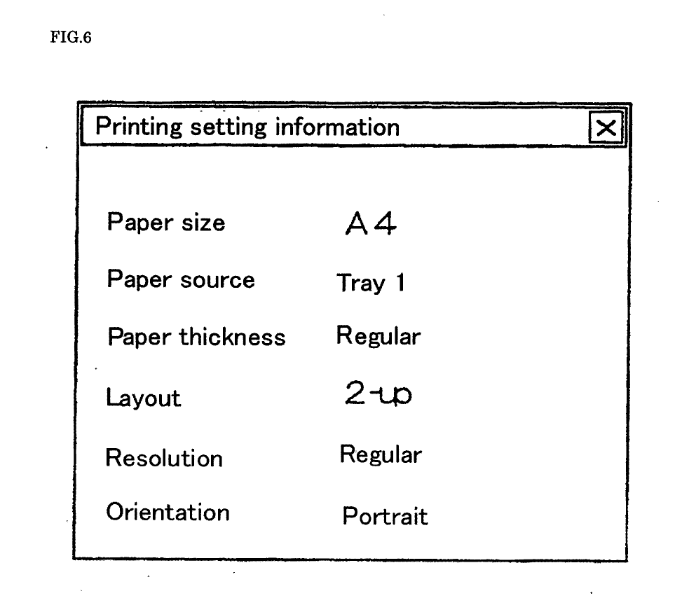

First, in a case of printing the document generated with the application 11, the operator is to carry out operation such as, for example, selecting a “printing” menu from a “file” menu of the application 11 such as shown in FIG. 2, as explained above for the related arts, displaying a printing dialog such as shown in FIG. 3, as explained above likewise, selecting the printer performing the printing from the printing dialog, and clicking the “OK” button.

In that case, the application 11 first retrieves the printing setting information of the printer driver 40 for the selected printing apparatus 51 with using the function provided by the operating system 20 or by the graphic device interface 21. The operator then, upon manipulating the inputting apparatus 32, selects the menu or clicks the button, for printing the document generated by the application 11.

Subsequently, the application 11 displays, according to the operation method by the operator, the printing dialog such as shown in FIG. 3. Furthermore, where the operator selects a “property” button upon the clicking operation, the application 11 renders, via the graphic device interface 21, the printing setting information displaying and changing unit 42 of the printer driver display a printing setting screen such as shown in FIG. 4, as explained above on the displaying apparatus 31. The application 11 then allows the operator select his desired printing setting information with use of the inputting apparatus 32.

In the screen of the printing dialog, subsequently, when the operator clicks the “OK” button, the application 11 notifies, with the graphic device interface 21, the printer driver 40 about the printing setting information while carrying out the printing start instruction. Where the printing instruction and data receiver 41 receives the printing start instruction, the printer driver 40 memorizes the current printing setting information designated with the application 11 in the printing setting information memory 44 and suspends receptions of, via the graphic device interface 21, the printing data from the application 11. Herein, in a case of no concrete means for suspending, e.g., in a case of a system in which the processing does not proceed without responding to the calling of this time to the printer driver 40, the processing inside the driver may preferably continue without responding to the calling.

Subsequently, the printing setting information displaying and changing unit 42 retrieves a setting value (hereinafter, referred to as “bDispEnable” or “value of bDispEnable”) indicating, according to the printing start instruction, as to whether the printing setting is to be displayed on the displaying apparatus 31 based on the printing setting information as well as a setting value (hereinafter, referred to as “Time Out” or “value of Time Out”) for a time-out of time during the displaying of the printing setting information on the displaying apparatus 31. The above described bDispEnable and Time Out are to be set prior to start of the printing with the application 11, upon the operator's use of the displaying apparatus 31 and the inputting apparatus 32. When the operator does not set those values, default values previously set are used.

The printer driver 40 makes the judgment, according to whether or not the Time Out is equal to zero, as to whether the printing setting information is to be displayed on the displaying apparatus 31. Herein, the printing setting information is to be displayed where the bDispEnable is TRUE in a Boolean value, whereas the printing setting information is not to be displayed where the bDispEnable is FALSE in the Boolean value. Additionally, the Time Out indicates the period of time up to the time-out. According to this embodiment, the bDispEable converges on the setting value for the Time Out, and where the Time Out is equal to zero, the bDispEnable is synonymous with a FALSE state, whereas where the Time Out is not equal to zero, the bDispEnable is synonymous with a TRUE state. Furthermore, in this embodiment, the values of the bDiapEnable and the Time Out are held as the printing setting information but may be defined by other memory means.

Where the Time Out is not equal to zero, i.e., where the bDispEnable is TRUE, the printing setting information displaying and changing unit 42 displays the printing setting information on the displaying unit 31 based on the printing setting information memorized in the printing setting information memory 44, or namely performs the printing setting information displaying and changing processing with the timer. In that case, the printing setting information displaying and changing unit 42 displays, based on the printing setting information, the printing setting information having contents such as, e.g., Paper size, Paper source, Paper thickness, Layout, Resolution, and Orientation, memorized in the memory 44 as shown in FIG. 6.

Next, the timer unit 43 carries out the timer processing. In that case, the timer unit 43 retrieves the time-out time from parameters, thereby storing the time-out time in the Time Out. The timer unit 43 stores the current time in Start Time as the displaying starting time. The timer unit 43 subsequently makes the comparison between the current time and the Start Time, thereby making the judgment as to whether the current time passes over the time-out time from the Start Time. The timer unit 43 waits until the time-out time passes, completes the timer processing when the time-out time passes, deletes the printing setting information displayed on the displaying unit 31, and completes the displaying of the printing setting information.

Receptions of the printing data from the application 11 are subsequently started, and the printing data converter 45 converts, based on the printing setting information stored in the printing setting memory 44, the printing data drawing received with the printing instruction and data receiver 41 from the application 11 into the printing controlling data 46 depending on the printing apparatus 51. The data transmitter 47 then transmits the printing controlling data 46 to the printing apparatus 51, so the printing apparatus 51 forms the images to carry out the corresponding printing.

The flow chart showing the operation of the printer driver 40 is explained next. The printer driver 40 receives printing start instruction from the application 11 at the step S1. The printer driver 40 stores the current printing setting information of the application 11 at the step S2. The receiving of the printing data of the application 11 is suspended at the step S3. At the step S4, the printer driver 40 retrieves the Time Out for the time during the displaying of the printing setting information the displaying apparatus 31. The printer driver 40 makes the judgment at the step S5 as to whether the Time Out is equal to zero. Where the Time Out is equal to zero, the operation goes to the step S7, whereas where the Time Out is not equal to zero, the operation goes to the step S6. The printing setting information displaying and changing processing with the timer is carried out at the step S6. The receiving of the printing data from the application 11 is started at the step S7. The printing data drawing is converted into the printing controlling data 46 based on the printing setting information at the step S8. The printing controlling data 46 are transmitted to the printing apparatus 51, so this processing is completed at the step S9.

The flow chart showing the subroutine for the printing setting information displaying and changing processing with the timer is next explained. The current printing setting information is displayed on the displaying apparatus 31 based on the printing setting information at the step S6-1. The timer processing is carried out at the step S6-2. The displaying of the printing setting information is completed and this processing is completed at the step S 6-3.

The flow chart showing the subroutine for the timer processing is next explained. The time-out time is retrieved from the parameters and stored in the Time Out at the step S6-2-1. The current time is stored as a starting time in the Start Time at the step S6-2-2. The judgment is made at the step S6-2-3 as to whether the current time passes over the time-out time from the Start Time. When the current time passes over the time-out time from the Start Time, this processing is completed, whereas when the current time does not pass over the time-out time from the Start Time, this processing becomes waiting.

As described above, in this embodiment, the printing setting information can be displayed merely by executing the printing even where the operator dose not understand well the operation for displaying the printing setting information. Accordingly, the manipulation for confirming the printing setting information can be simplified by omitting the operation for displaying the printing setting information. Usability of this apparatus is greatly improved because the displaying of the printing setting information prior to the printing makes it possible to confirm as to whether the printing is based on the unintended setting or not, and the printing can be continued without the operator's particular operation by starting the printing when certain time passes after the displaying of the printing setting information.

The second embodiment of this invention will be next explained. Structured same as the first embodiment is assigned with the same numerals to omit duplicating explanation. Explanation for the same operation and effect as the first embodiment is also omitted.

To confirm the details of the printing setting in a case of printing upon displaying the printing dialog, the operator is to display printing setting dialog corresponding to the driver for the printer by clicking the “property” or the “detail setting” button, clicks the “OK” button with the printing setting dialog corresponding to the driver for the printer after he confirms the printing setting, and clicks again the “OK” button to start the printing after returning to the printing dialog. Therefore, this processing for the printing takes time and loses good usability.

In a case of printing with displaying the printing dialog, when the operator executes the printing by clicking the “OK” button without confirming the details of the printing setting, it happens that the printing is executed based on the different printing setting from his originally intended printing result. In displaying the printing icon on the toolbar by the application, when the application starts upon the operator's clicking of the printing icon, without displaying the printing dialog, the same thing as described above may happen since the details of the printing setting are not confirmed. When the application for recognizing the document file is started and to start immediately the printing processing by dragging and dropping a document file as a printing object to the icon of the printer executing the printing in the “printer” or “printer and facsimile” folder, the same thing as above may happen since the details of the printing setting are not confirmed. As described above, the useless printed material may be produced when the printing is executed based on the different setting from the originally desired printing result.

When the printing setting is displayed for confirmation of the details of the printing setting after the printing processing is started with the application, the printing is not to be carried out until the operator clicks the “OK” button upon confirmation in a state where the confirmation dialog for the details of the printing setting is displayed. Thus, it may happen that where the operator leaves his seat immediately after the printing processing is started and thereafter returns to the seat at a time when the printing is supposed to be completed the printing is not yet started since the confirmation dialog for the details of the printing setting has been displayed as waiting for clicking action of “OK” dialog. In this case, the operator wastes his time.

In this embodiment, in a case of the displaying of the confirmation dialog for the details of the printing setting, the delay can be prevented by continuing or resuming the printing when certain time passes without any input by the operator.

In this embodiment, the composition of the image processing apparatus 10 is same as that of the first embodiment, so the explanation for FIG. 1 is quoted. It is to be noted that in this embodiment, where the operator does not input when the dialog for confirming or changing the details of the printing setting information is displayed after the printing processing with the application is started, the printing is to be continued or resumed after certain time passes, whereas when the operator inputs before certain time passes, the printing setting information is to be updated upon canceling the timer and receiving the input by the operator.

The operation of the image processing apparatus 10 according to this embodiment is next explained.

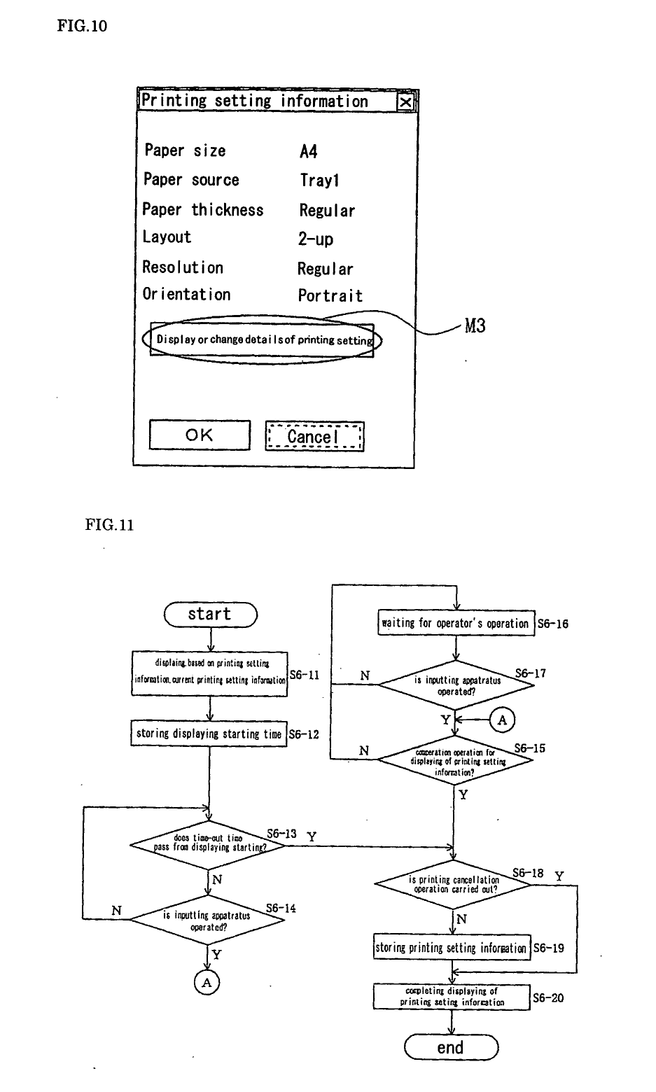

FIG. 10 is a view showing a display view of the printing setting information according to the second embodiment of this invention, and FIG. 11 is a flow chart showing the subroutine for the printing setting information displaying and changing processing with the timer according to the second embodiment of this invention.

In this embodiment, the operation other than that the printing setting information displaying and changing processing with the timer is the same as that according to the first embodiment. Thus, a duplicated explanation is omitted, and only the operation of the printing setting information displaying and changing processing with the timer is explained.

In this embodiment, the time-out status of the displaying time of the printing setting information on the displaying apparatus 31 is not processed with the module which is independent as the timer, but detected by a method for measuring the time in a flow of the operations for displaying and input waiting.

With the printing setting information displaying and changing processing with the timer, the printing setting information displaying and changing unit 42 displays, based on the printing setting information, the printing setting information having contents, e.g., such as shown in FIG. 10. Where the button such as shown by M3 in FIG. 10 is clicked, the printing setting dialog as shown in FIG. 4, corresponding to the driver for the printer executing the printing is displayed, thereby enabling the operator to change the printing setting information.

Next, the timer unit 43 measures the time, and the processing waits for the operator's input with the inputting apparatus 32 until the time indicated by the Time Out passes. The timer unit 43, in that case, stores the current time as the displaying starting time in the Start Time. The comparison is subsequently made between the current time and the Start Time, thereby making the judgment as to whether the current time passes over the time-out time from the Start Time. Where the time-out time does not pass yet, the judgment is made as to whether the operator inputs upon operating the inputting apparatus 32, and where the operator does not make an input, the processing waits until the time-out time passes. When the operator inputs upon operating the inputting apparatus 32, the judgment is made as to whether the input operation is for completion operation for the displaying of the printing setting information. When the input operation is not for the completion of the operation for the displaying of the printing setting information, the processing waits until the operator carries out the completion of the operation for the displaying of the printing setting information upon using the inputting apparatus 32. When the operator carries out the completion of the operation for the displaying of the printing setting information, the judgment is then made as to whether printing cancellation operation is carried out. When the printing cancellation is selected, the printing setting information is deleted and completed from the displaying apparatus 31, thereby canceling the printing. When the operator selects the “OK” for instructing to start the printing, not the printing cancellation, the processing stores the printing setting information in the printing setting information memory 44, deletes the printing setting information displayed on the displaying apparatus 31, and completes the displaying of the printing setting information. The printing data converter 45 subsequently converts the printing data drawing of the application 11 received with the printing instruction and data receiver 41, based on the printing setting information stored in the printing setting information memory 44, into the printing controlling data 46 depending on the printing apparatus 51, and the data transmitter 47 transmits the printing controlling data 46 to the printing apparatus to render the printing apparatus 51 carry out the printing.

The flow chart is next explained. The current printing setting information is displayed, based on the printing setting information, on the displaying apparatus 31 at the step S6-11. The displaying starting time is stored at the step S6-12. The judgment is made at the step S6-13 as to whether the time-out time passes from the displaying starting time. When the time-out time passes from the displaying starting time, the operation goes to the step S6-18, whereas the time-out time does not pass yet from the displaying starting time, the operation goes to the step S6-14. The judgment is made at the step S6-14 as to whether the operator operates the inputting apparatus 32. Where the operator operates the inputting apparatus 32, the operation goes to the step S6-15, whereas where the operator does not operate the inputting apparatus 32, the operation returns to the step S6-13. The judgment is made at the step S6-15 as to whether the input operation is the completion of the operation for the displaying of the printing setting information. Where the input operation is the completion of the operation for the displaying of the printing setting information, the operation goes to the step S6-18, whereas where the input operation is not the completion of the operation for the displaying of the printing setting information, the operation goes to the step S6-16. The processing waits at the step S6-16 until the operator operates the inputting apparatus 32. The judgment is made at the step S6-17 as to whether the operator operates the inputting apparatus 32. Where the operator operates the inputting apparatus 32, the operation goes to the step S6-15, whereas where the operator does not operate the inputting apparatus 32, the operation returns to the step S6-16. The judgment is made at the step S6-18 as to whether the printing cancellation operation is carried out. Where the printing cancellation operation is carried out, the operation goes to the step S6-20, whereas where the printing cancellation operation is not carried out, the operation goes to the step S6-19. At the step S6-19, the printing setting information changed by the operator is stored in the printing setting information memory 44. The displaying of the printing setting information is completed and this processing is completed at the step S6-20.

As described above, in this embodiment, even where the operator does not understand well the operation for displaying the printing setting information, the printing setting information can be displayed only by executing the printing. The confirmation operation for the printing setting information, furthermore, can be simplified by omitting the operation for displaying the printing setting information. Additionally, the confirmation can be made, by displaying the printing setting information prior to printing, as to whether the printing is based on the unintended setting, and further, in a case of the unintended printing, the printing can be discontinued by operating the inputting apparatus 32, so the useless printing can be omitted. The useless printing, furthermore, can be omitted by changing the setting without discontinuing the printing and thereafter printing based on the new setting. Also, even in a case of no continuing operation by the operator, the apparatus resumes printing after certain time passes, so it does not happen that the operator uselessly wastes time, such that the operator notices the printing is not carried out when returning to his seat at a time the printing is supposed to be completed after leaving his seat after the start of the printing processing.

The third embodiment is next explained. Structures same as in the first embodiment and the second embodiment are assigned with the same numerals to omit duplicated explanation. Explanation for the same operation and effect as the first embodiment and the second embodiment is also omitted.

In this embodiment, the composition of the image processing apparatus 10 is the same as that of the first embodiment, so the explanation for FIG. 1 is quoted. It is to be noted in this embodiment, where the operator does not input when the dialog for confirming or changing the details of the printing setting information is displayed after the printing processing with the application 11 is started, the printing is to be continued or resumed after certain time passes, whereas when the operator inputs before certain time passes, transition until certain time passes is displayed on the screen, in a case of canceling the operation of the timer, receiving the input by the operator, and updating the printing setting information.

Structures of the image processing apparatus 10 thus composed are next explained.

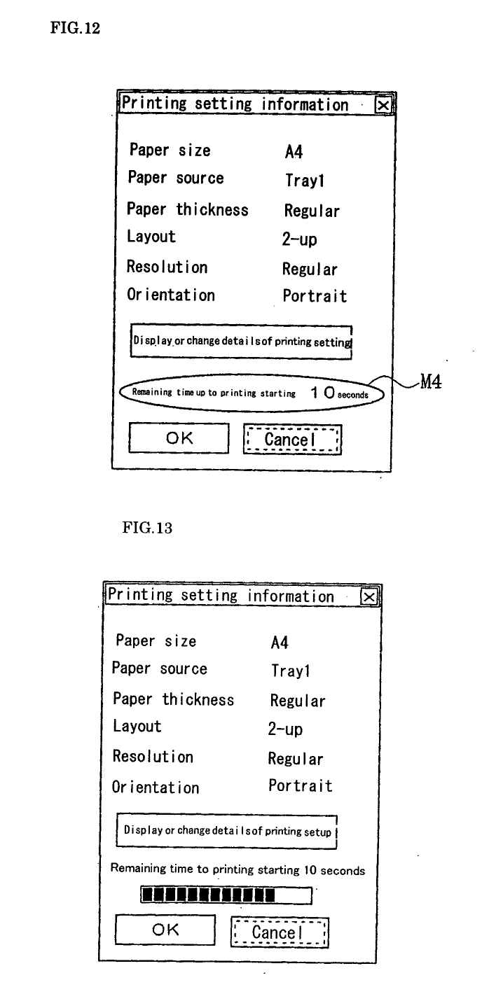

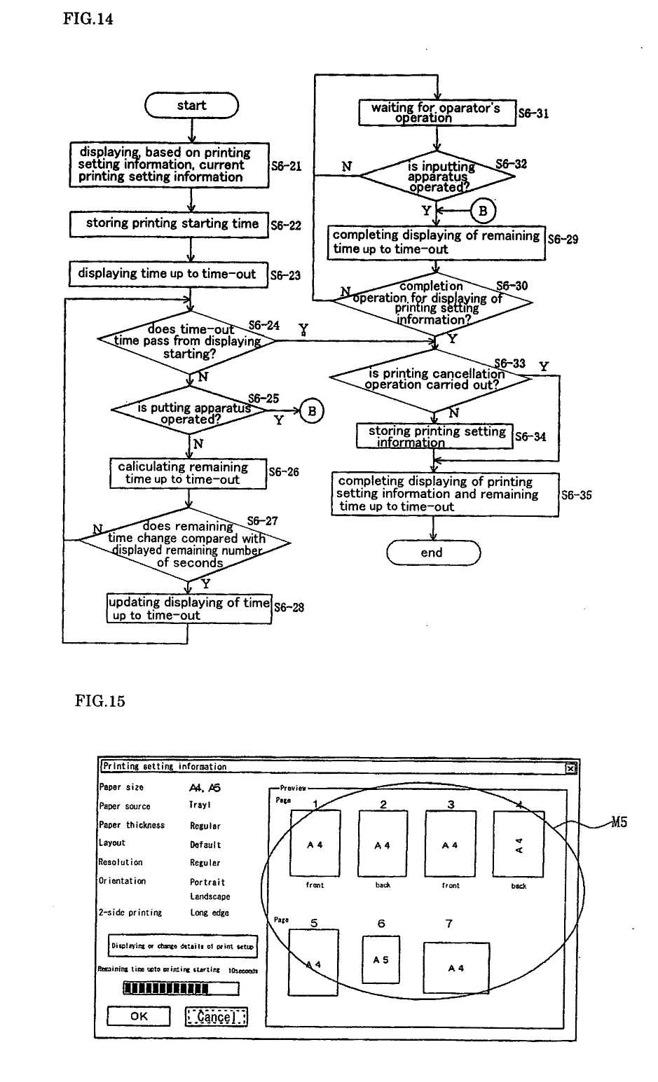

FIG. 12 is the first view showing a display view of printing setting information according to the third embodiment of this invention; FIG. 13 is the second view showing a display view of the printing setting information according to the third embodiment of this invention; and FIG. 14 is a flow chart showing a subroutine for the printing setting information displaying and changing processing with the timer according to the third embodiment of this invention.

In this embodiment, operation other than the printing setting information displaying and changing processing with a timer is same as that according to the first embodiment, and thus corresponding explanation is omitted, so only the operation for the printing setting information displaying and changing processing with the timer is explained.

In this embodiment, as same as the second embodiment, the time-out of the time during the displaying of the printing setting information on the displaying apparatus 31 is not processed with the module which is independent as the timer, but detected by a method for measuring the time in a flow of the operations for displaying to waiting for the input. It is to be noted that in this embodiment, the processing is added to the second embodiment, such that the printing setting information displaying and changing unit 42 displays, in a case, e.g., where one minute passes, the state where one minute already passes on the displaying apparatus 31 until the time indicated by the Time Out passes from the displaying starting.

That is, with the printing setting information displaying and changing processing with the timer, the printing setting information displaying and changing unit 42 displays, based on the printing setting information, the printing setting information having contents such as, e.g., shown in FIG. 12 and FIG. 13 on the displaying apparatus 31. In that case, remaining time is displayed by the second.

The timer unit 43, next, measures the time, and the processing waits for the operator's input with the inputting apparatus 32 until the time indicated by the Time Out passes. The timer unit 43, in that case, stores the current time as the displaying starting time in the Start Time. A value as converted into second from the setting value for the time-out of the time during the displaying of the printing setting information on the displaying apparatus 31 is displayed as being showed by M4 in FIG. 12.

The comparison is subsequently made between the current time and the Start Time to make the judgment as to whether the current time passes over the time-out time from the Start Time. When the time-out time does not pass yet, the judgment is made as to whether the operator inputs upon operating the inputting apparatus 32, and where the operator does not input yet, remaining time is calculated based on the current time, and the values of the Start Time and the Time Out. The remaining time is calculated by a following formula (1). Accordingly, the current time, and the values of the Start Time and the Time Out are same in the unit.
Remaining time=Time Out−(Current time−Start Time) Formula (1)

Next, the calculated remaining time is converted into second, and compared with the remaining number of seconds, so the judgment is made as to whether the remaining number of seconds displayed on the displaying apparatus 31 changes. Where the remaining number of seconds changes, the processing update to display the M4 in FIG. 12 to the value of the remaining time calculated and converted into second.

Furthermore, as described above, the judgment is made as to whether the operator inputs upon operating the inputting apparatus 32, and when the operator inputs upon operating the inputting apparatus 32, the display of the M4 in FIG. 12 showing the remaining time is deleted and completed. The judgment is further made as to whether the input operation is the completion operation for the displaying of the printing setting information. Where the input operation is not the completion operation for the displaying of the printing setting information, the processing waits until the operator carries out the completion operation for the displaying of the printing setting information with use of the inputting apparatus 32. When the operator carries out the completion operation for the displaying of the printing setting information, the judgment is made as to whether the printing cancellation operation is carried out. Where the printing cancellation is selected, the printing setting information is deleted from the displaying apparatus 31, thereby being completed to cancel the printing. When the operator selects the “OK” for instructing the start of the printing, not the printing cancellation, the printing setting information is stored in the printing setting information memory 44, and the printing setting information displayed on the displaying apparatus 31 is deleted, so the displaying of the printing setting information is completed. The printing data converter 45 converts, based on the printing setting information stored in the printing setting information memory 44, the printing data drawing of the application 11 received with the printing instruction and data receiver 41 into the printing controlling data 46 depending on the printing apparatus 51, and thereafter the printing data transmitter 47 transmits the printing controlling data 46 to the printing apparatus 51, so the printing apparatus 51 carries out the printing.

The flow chart is next explained. The current printing setting information is displayed on the displaying apparatus 31 based on the printing setting information at the step S6-21. The displaying starting time is stored at the step S6-22. The remaining time up to the Time Out is displayed on the displaying apparatus 31 at the step S6-23. The judgment is made at the step S6-24 as to whether the time-out time passes from the start of the displaying. When the time-out time passes from the start of the displaying, the operation goes to the step S6-33, whereas when the time-out time does not pass yet from the start of the displaying, the operation goes to the step S6-25. The judgment is made at the step S6-25 as to whether the operator operates the inputting apparatus 32. When the operator operates the inputting apparatus 32, the operation goes to the step S6-29, whereas when the operator does not operate the inputting apparatus 32, the operation goes to the step S6-26. The remaining time up to the Time Out is calculated at the step S6-26. The judgment is made at the step S6-27 as to whether the remaining time changes compared with the displayed remaining time. When the remaining time changes, the operation goes to the step S6-28, whereas when the remaining time does not change, the operation returns to the step S6-24. The displaying of the time up to the Time Out is updated at the step S6-28. The displaying of the remaining time up to the Time Out is completed at the step S6-29. The judgment is made at the step S6-30 as to whether the input operation is the completion operation for the displaying of the printing setting information. When the input operation is the completion operation for the displaying of the printing setting information, the operation goes to the step S6-33, whereas when the input operation is not the completion operation for the displaying of the printing setting information, the operation goes to the step S6-31. The processing waits at the step S6-31 until the operator operates the inputting apparatus 32. The judgment is made at the step S6-32 as to whether the operator operates the inputting apparatus 32. When the operator operates the inputting apparatus 32, the operation goes to the step S6-29, whereas when the operator does not operate the inputting apparatus 32, the operation returns to the step S6-31. The judgment is made at the step S6-33 as to whether the printing cancellation operation is carried out. Where the printing cancellation operation is carried out, the operation goes to the step S6-35, whereas where the printing cancellation operation is not carried out, the operation goes to the step S6-34. The printing setting information changed by the operator is stored in the printing setting information memory 44 at the step S6-34. The displaying of the printing setting information and the remaining time up to the Time Out is completed, and this processing are completed and this processing is completed at the step S6-35.

As described above, in this embodiment, in addition to the effect of the second embodiment, it is possible to inform the operator of the remaining operatable time by displaying the remaining time during the displaying of the printing setting information, and therefore the operator can assuredly operate at ease.

The fourth embodiment of this invention will be next explained. Composed same as the first embodiment, the second embodiment, and the third embodiment is assigned same numeral to omit corresponding explanation. Explanation for the same operation and effect as the first embodiment, the second embodiment, and the third embodiment is also omitted.

In this embodiment, the composition of the image processing apparatus 10 is same as that of the first embodiment, so the explanation for FIG. 1 is quoted. It is to be noted that in this embodiment, after the application 11 starts the printing processing with defining the document of one or several pages as single job, the printing instruction and data receiver 41 receives the entire printing data of the single job from the application 11, and the printing setting information memory 44 stores the printing setting information immediately after the start of the printing processing as well as the printing setting information changed in the process of in single jog. Before printing for real, the dialog for displaying, with simplified expression, the printing setting information for each page in the single job is displayed, for confirmation or changing of the details of the printing setting information, on the displaying apparatus 31. Herein, when the operator does not input, the printing is continued after certain time passes, whereas when the operator inputs before certain time passes, the timer is cancelled, and the printing setting information is updated upon receiving the input by the operator.

Operation of the image processing apparatus 10 according to this embodiment is next explained.

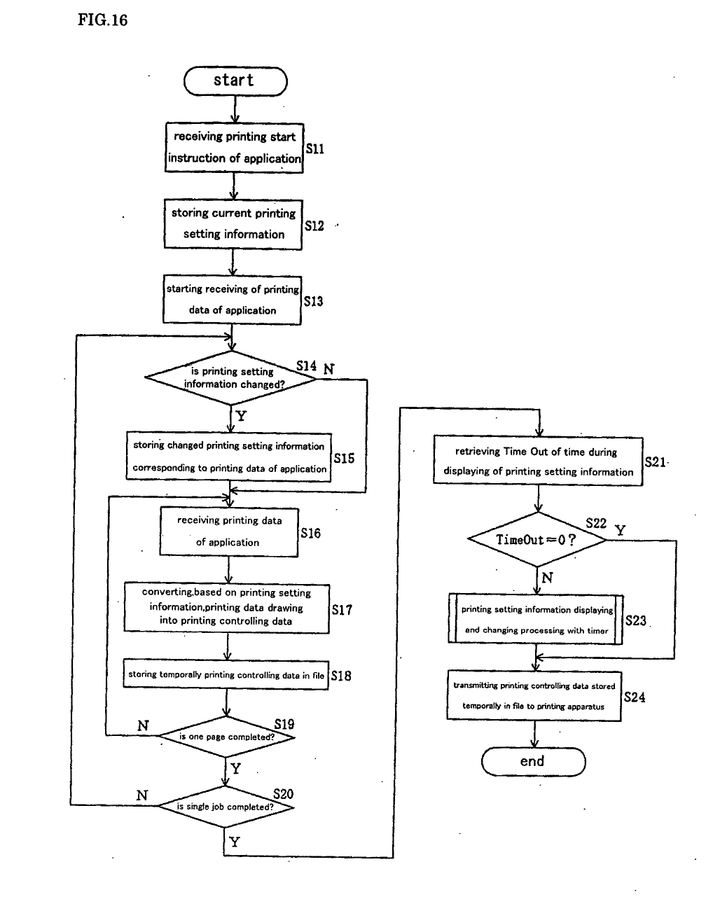

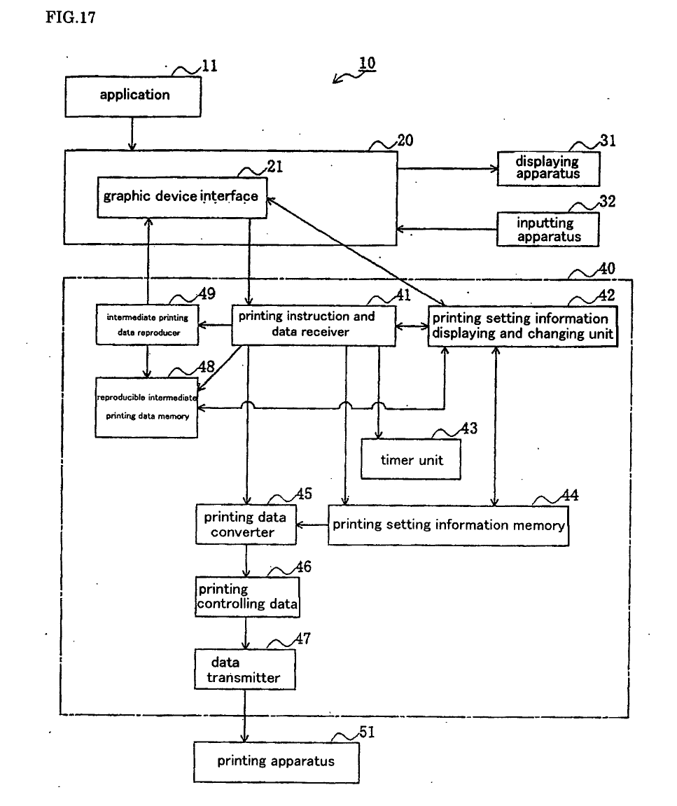

FIG. 15 is a view showing a display view of the printing setting information according to the fourth embodiment of this invention; and FIG. 16 is a flow chart showing operation of the printer driver according to the fourth embodiment of this invention.

First, when the operator clicks the “OK” button displayed in the screen of the printing dialog such as shown in FIG. 3, the printing setting information is notified via the graphic device interface 21 to the printer driver 40 while the printing start instruction is carried out. The printer driver 40 receives the printing start instruction of the application 11 with the printing instruction and data receiver 41.

In the first embodiment and the second embodiment, in the meantime, after receiving the printing start instruction with the printing instruction and data receiver 41, the printer driver 40 suspends the receiving of the printing data from the application 11, and displays the printing setting, according to the printing start instruction, on the displaying apparatus 31 based on the printing setting information. In this embodiment, on the other hand, after receiving the printing start instruction with the printing instruction and data receiver 41, the printer driver 40 memorizes the printing setting information designated by the application 11 with the printing setting information memory 44, and receives continuously the printing data without suspending the receiving of the printing data form the application 11 until the single job is completed.

The printer driver 40, herein, memorizes the printing data from the application 11 and the printing setting information with the printing setting information memory 44 while memorizes, where the application 11 changes the printing setting information in the process of the single job, the changed printing setting information and page(s) with the printing setting information memory 44. As shown by M5 in FIG. 15, for example, paper size, paper direction, or the like in the page(s) of the single job are displayed with the simplified images, according to the printing setting information memorized in the printing setting information memory 44. Furthermore, in memorizing the printing setting information designated with the application 11 with the printing setting information memory 44, the printer driver 40 memorizes the starting time of the job in addition to the printing setting information, and further, memorizes the printing setting information as the current setting.

The printer driver 40, subsequently, starts receiving the printing data from the application 11 via the graphic device interface 21. It is to be noted that where there is not any concrete means for starting, the image processing apparatus 10 may respond this time's calling to the printer driver 40 and exit the processing from the printer driver 40.

The printer driver 40 next makes the judgment as to whether the application 11 changes the printing setting information in the process of the single job, and where the application 11 changes the printing setting information, the printer driver 40 stores the changed printing setting information in the printing setting information memory 44. In that case, the printing setting information is stored separately, not written over the information already stored, thereby stored with added with a page number wherein the printing setting is changed, as shown by the M5 in FIG. 15. The printing setting information is, furthermore, stored as the current setting upon overwriting. The printer driver 40 receives the printing data from the application 11 via the graphic device interface 21. Where the printing setting information is not changed, the printer driver 40 receives directly the printing data.

The printer driver 40 converts, based on the printing setting information stored as the current setting memorized in the printing setting information memory 44, the printing data drawing of the application 11 received with the printing instruction and data receiver 41 into the printing controlling data 46 depending on the printing apparatus 51. Furthermore, the converted printing controlling data 46 are temporally saved as stored in the file.

The printer driver 40, subsequently, makes the judgment as to whether one page is completed. Where one page is not completed yet, the printer driver 40 receives again the printing data form the application 11 via the graphic device interface 21. Where one page is completed, the printer driver 40 further makes the judgment as to whether the single job is completed. Where the single job is not completed, the judgment is further made as to whether the application 11 changes again the printing setting information in the process of the job. Where the single job is completed, the printing setting information displaying and changing unit 42 retrieves the bDispEnable defined as the setting value, indicating according to the printing start instruction, based on the printing setting information, as to whether the printing setting is to be displayed on the displaying apparatus 31 as well as retrieves the Time Out defined as the setting value for the time-out of the time during the displaying of the printing setting information on the displaying apparatus 31.

The printer driver 40, next, makes the judgment, according to whether or not the Time Out is equal to 0, as to whether the printing setting information is to be displayed on the displaying apparatus 31. Where the Time Out is not equal to 0, the printing setting information displaying and changing unit 42 displays, based on the printing setting information memorized in the printing setting information memory 44, the printing setting information on the displaying apparatus 31, that is, the printing setting information displaying and changing processing with the timer is carried out. The printing setting information displaying and changing processing with the timer, herein, is same as that of the third embodiment, so corresponding explanation is omitted. Where the Time Out is equal to 0, the printing setting information displaying and changing processing is not carried out.

The data transmitter 47, subsequently, transmits the printing controlling data 46 temporally saved as stored in the file to the printing apparatus 51, and the printing apparatus 51 carries out the image forming processing and the printing.

The flow chart showing the operation of the printer driver 40 is next explained. The printer driver 40 receives the printing starting instruction with the application 11 at the step S11. The current printing setting information of the application 11 is stored at the step S12. The printer driver 40 starts receiving the printing data from the application 11 at the step S13. The judgment is made at the step S14 as to whether the printing setting information is changed. Where the printing setting information is changed, the application goes to the step S15, whereas where the printing setting information is not changed, the operation goes to the step S16. The printer driver 40 stores the changed printing setting information of the printing data of the application at the step S15. The printer driver 40 receives the printing data of the application 11 at the step S16. The printing data drawing is converted, based on the printing setting information, into the printing controlling data 46 at the step S17. The printing controlling data 46 are temporally saved as stored in the file at the step S18. The judgment is made at the step S19 as to whether one page is completed. Where one page is completed, the operation goes to the step S20, whereas where one page is not completed, the operation returns to the step S16. The judgment is made at the step S20 as to whether the single job is completed. Where the single job is completed, the operation goes to the step S21, whereas where the single job is not completed, the operation returns to the step S14. At the step S21, the printer driver 40 retrieves the Time Out defined as the setting value for the time-out of the time during the displaying of the printing setting information on the displaying apparatus 31. The judgment is made at the step S22 as to whether the Time Out is equal to 0. Where the Time Out is equal to 0, the operation goes to the step S24, whereas where the Time Out is not equal to 0, the operation goes to the step S23. The printing setting information displaying and changing processing with the timer is carried out at the step S23. The printing controlling data 46 stored temporally in the file is transmitted to the printing apparatus 51, and this processing is completed at the step S24.

As described above, in this embodiment, in addition to the effect of the third embodiment, it is possible to let the operator know about the printing setting information more plainly by displaying summaries of the printing results of the printing data. Furthermore, even where pages having different printing setting information mix in the single job, those information can be visually displayed.

The fifth embodiment of this invention will be next explained. Composed same as the first embodiment to the fourth embodiment is assigned same numeral to omit corresponding explanation. Explanation for the same operation and effect as the first embodiment to fourth embodiment is also omitted.

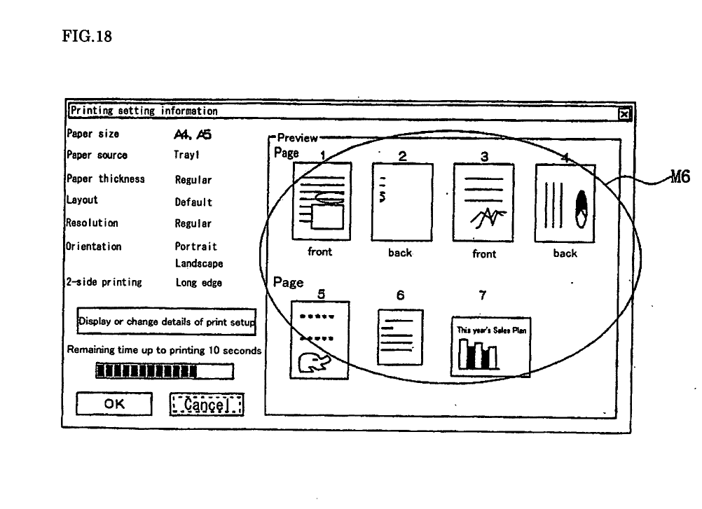

FIG. 17 is a block diagram showing a composition of the image processing apparatus according to the fifth embodiment of this invention.

The image processing apparatus 10 of this embodiment is different from that of the first embodiment to the fourth embodiment in that the printer driver 40 further has, as shown in FIG. 17, a reproducible intermediate printing data memory 48 serving as an intermediate data memory as well as an intermediate printing data reproducer 49. Herein, the reproducible intermediate printing data memory 48 memorizes, as the reproducible intermediate printing data, the printing data drawing received with the printing instruction and data receiver 41, carried out for the printing of the document, with the application 11 via the graphic device interface 21. It is to be noted that peculiar format of the intermediate printing data is not required but, for example, a format provided with the operating system 20 may be acceptable. Furthermore, the intermediate printing data reproducer 49 reproduces, in the graphic device interface 21, the reproducible intermediate printing data stored with the reproducible intermediate data memory 48, thereby reproducing the reproducible intermediate printing data as the printing data drawing.

In this embodiment, after printing processing is started in a condition where the document of one or several pages with the application 11 is considered as single job, the printing instruction and data receiver 41 receives the entire printing data of the single job from the application 11, and the above data are stored as the reproducible intermediate printing data in the printing setting information memory 44. Furthermore, the printing setting information immediately after the start of the printing processing as well as the printing setting information changed in the process of the single job are stored, and before printing for real, the dialog for displaying, with simplified expression, the printing setting information for each page in the single job on and the reproducible intermediate printing data is displayed, for confirmation or changing of the details of the printing setting information, on the displaying apparatus 41.

Operation of the image processing apparatus 10 thus composed is next explained.

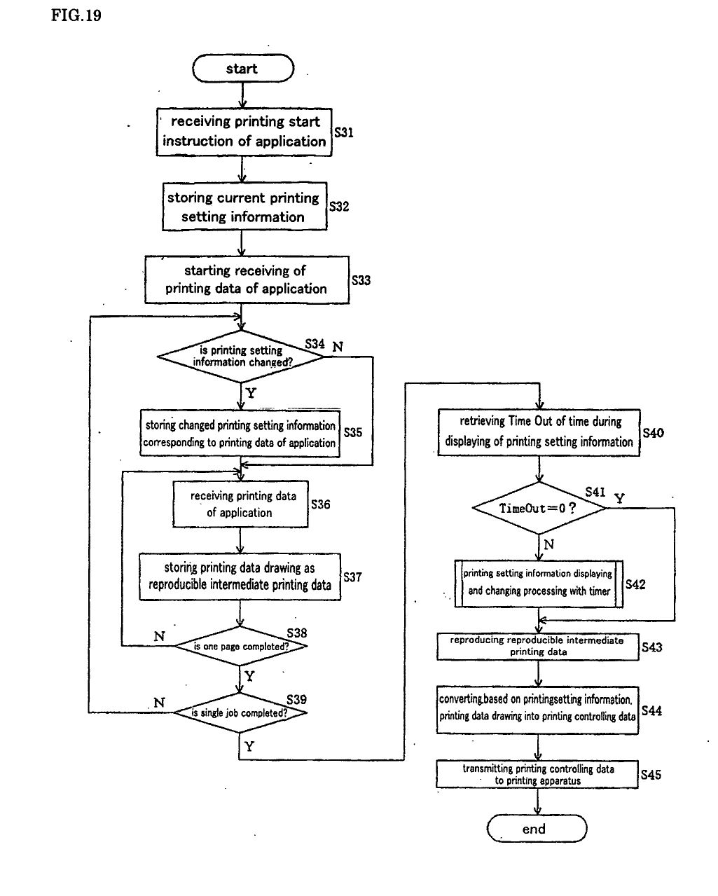

FIG. 18 is a view showing a display example of the printing setting information according to the fifth embodiment of this invention; and FIG. 19 is a flow chart showing operation of the printer driver according to the fifth embodiment of this invention.

In the meantime, the printer driver 40 according to the fourth embodiment is to receive continuously, after receiving the printing start instruction with the printing instruction and data receiver 41, the printing data without suspending the receiving of the printing data from the application 11 until the single job is completed. Furthermore, the printing data converter 45 is to convert, based on the printing setting information memorized with the printing setting information memory 44, the printing data into the printing controlling data 46 depending on the printing apparatus 51, and the printing data is to be stored in the printing setting information memory 44.

The printing driver 40 according to this embodiment, on the other hand, likewise receives continuously, after receiving the printing start instruction with the printing instruction and data receiver 41, the printing data without suspending the receiving of the printing data from the application 11 until the single job is completed. However, when the printing is continued after the printing data are stored as the reproducible intermediate printing data in the reproducible intermediate printing data memory 48 and the printing setting information is displayed on the displaying apparatus 31, the intermediate printing data reproducer 49 is to reproduce the reproducible intermediate printing data stored with the reproducible intermediate printing data memory 48 on the graphic device interface 21 to reproduce the above data as the printing data drawing.

First, when the operator clicks the “OK” button displayed in the screen of the printing dialog such as shown in FIG. 3, the printing setting information is notified to the printer driver 40 via the graphic device interface 21 while the printing start instruction is carried out. The printer driver 40 receives the printing start instruction by the application 11 with the printing instruction and data receiver 41. The printer driver 40, furthermore, memorizes the printing setting information designated by the application 11 with the printing setting information memory 44, and receives continuously the printing data without suspending the receiving of the printing data from the application 11 until the single job is completed.

The printer driver 40, subsequently, memorizes the printing data from the application 11 as well as the printing setting information with the printing setting information memory 44, while storing the changed printing setting information and page(s) in the printing setting information memory 44 when the application 11 changes the printing setting information in the process of the single job. The printing setting information is, additionally, stored as the information indicating the starting time of the job. The printing setting information is, furthermore, stored as the current setting also.

The printer driver 40, subsequently, starts receiving the printing data from the application 11 via the graphic device interface 21. It is to be noted that where there is not any concrete means for starting, the image processing apparatus 10 may respond this time's calling to the printer driver 40 and exit the processing from the printer driver 40.

The printer driver 40 next makes the judgment as to whether the application 11 changes the printing setting information in the process of the job, and where the application 11 changes the printing setting information, the printer driver 40 stores the changed printing setting information in the printing setting information memory 44. In that case, the printing setting information is stored separately, not written over the information already stored, thereby being stored with added with a page number wherein the printing setting is changed, as shown by M6 in FIG. 18. The printing setting information is, furthermore, stored as the current setting upon the overwriting. The printer driver 40, subsequently, receives the printing data from the application 11 via the graphic device interface 21. Where the printing setting information is not changed, the printer driver 40 receives directly the printing data.

The printer driver 40 saves and stores, as the reproducible intermediate printing data, the printing data drawing of the application 11 received with the printing instruction and data receiver 41 in the reproducible intermediate printing data memory 48. As shown by the M6 in FIG. 18, for example, the printer driver 40 displays the image reproduced upon downsizing to screen size, the reproducible intermediate printing data corresponding to the printing data drawing of the application 11, stored with the reproducible intermediate printing data memory 48.

The printer driver 40, subsequently, makes the judgment as to whether one page is completed. Where one page is not completed, the printer driver 40 receives again the printing data drawing from the application 11 via the graphic device interface 21. Where one page is completed, the judgment is further made as to whether the single job is completed. Where the single job is not completed, the judgment is made as to whether the application 11 changes again the printing setting information in the process of the job. Where single job is completed, the printing setting information displaying and changing unit 42 retrieves the bDispEnable defined as the setting value, indicating according to the printing start instruction, based on the printing setting information, as to whether the printing setting is to be displayed on the displaying apparatus 31 as well as retrieves the Time Out defined as the setting value for the time-out of the time during the displaying of the printing setting information on the displaying apparatus 31.

The printer driver 40 next makes the judgment based on whether or not the Time Out is equal to 0, as to whether the printing setting information is to be displayed on the displaying apparatus 31. Where the Time Out is not equal to 0, the printing setting information displaying and changing unit 42 displays, based on the printing setting information memorized in the printing setting information memory 44, the printing setting information on the displaying apparatus 31, that is, the printing setting information displaying and changing processing with the timer is carried out. The printing setting information displaying and changing processing with the timer is, herein, same as the processing according to the third embodiment, so the corresponding explanation is omitted. Additionally, where the Time Out is equal to 0, the printing setting information displaying and changing processing with the timer is not carried out.

The intermediate printing data reproducer 49 reproduces, on the graphic device interface 21, the reproducible intermediate printing data of the single job stored with the reproducible intermediate data memory 48, thereby reproducing the above data as the printing data drawing. The printing data converter 49 converts, based on the printing setting information memorized with the printing setting information memory 44, the printing data drawing received with the printing instruction and data receiver 41, reproduced with the intermediate printing data reproducer 49 into the printing controlling data 46 depending on the printing apparatus 51.

The data transmitter 47, next, transmits the converted printing controlling data 46 to the printing apparatus 51, so the printing apparatus 51 carries out the image forming processing to execute the printing.

The flow chart is next explained. The printing start instruction of the application 11 is received at the step S31. The current printing setting information of the application 11 is stored at the step S32. The receiving of the printing data from the application 11 is started at the step S33. The judgment is made at the step S 34 as to whether the printing setting information is changed. When the printing setting information is changed, the operation goes to the step S35, whereas when the printing setting information is not changed, the operation goes to the step S36. The changed printing setting information corresponding to the printing data of the application 11 is stored at the step S 35. The printing data of the application 11 is received at the step S36. The printing data of the application 11 is stored as the reproducible intermediate printing data at the step S37. The judgment is made at the step S38 as to whether one page is completed. Where one page is completed, the operation goes to the step S39, whereas where one page is not completed, the operation returns to the step S36. The judgment is made at the step S39 as to whether the single job is completed. Where the single job is completed, the operation goes to the step S40, whereas where the single job is not completed, the operation returns to the step S34. At the step S40, the printer driver 40 retrieves the Time Out defined as the setting value for the time-out of the time during the displaying of the printing setting information on the displaying apparatus 31. The judgment is made at the step S41 as to whether the Time Out is equal to 0. When the Time Out is equal to 0, the operation goes to the step S43, whereas where the Time Out is not equal to 0, the operation goes to the step S42. The printing setting information displaying and changing processing is carried out at the step S42. The reproducible intermediate printing data is reproduced at the step S43. The printing data drawing is converted at the step S44 based on the printing setting information into the printing controlling data 46. The printing controlling data 46 is transmitted to the printing apparatus 51, and this processing is completed at the step S45.

As described above, in this embodiment, in addition to the effect of the third embodiment, it is possible to let the operator know about the printing setting information more plainly by displaying previously summaries of the printing results of the printing data as well as the printing contents. Furthermore, even where pages having different printing setting information mix in the single job, those information can be visually displayed.

1. An image processing apparatus for transmitting image data to a printing apparatus, comprising:
a displaying unit for displaying, upon input of printing start instruction, information based on printing setting information;
a timer for measuring time during displaying operation of the displaying unit;
a data converter for converting printing data into printing controlling data based on the printing setting information at a time when the timer reaches a prescribed amount; and
an interface unit for transmitting the printing controlling data to an image forming unit of the printing apparatus.

2. The image processing apparatus according to claim 1, further comprising a printing setting information changing inputting unit for receiving a change of the printing setting information until that the timer reaches the prescribed amount.

3. The image processing apparatus according to claim 1, wherein the displaying unit shows a transition that the timer reaches the prescribed amount.

4. The image processing apparatus according to claim 1, wherein the displaying unit displays information based on the printing setting information and the printing data upon input of the printing start instruction.

5. The image processing apparatus according to claim 1, wherein the displaying unit displays a list of the summaries of the printing setting information upon input of the printing start instruction.

6. An image processing apparatus for transmitting image data to a printing apparatus, comprising:
a data converter for converting printing data into printing controlling data based on printing setting information upon input of printing start instruction;
a displaying unit for displaying, when the printing data are completed, information based on printing setting information; a timer for measuring time during displaying operation of the displaying unit; and
an interface unit for transmitting the printing controlling data to an image forming unit of the printing apparatus when the timer reaches a prescribed amount.

7. The image processing apparatus according to claim 6, further comprising a printing setting information changing inputting unit for receiving a change of the printing setting information until that the timer reaches the prescribed amount.

8. The image processing apparatus according to claim 6, wherein the displaying unit shows a transition that the timer reaches the prescribed amount.

9. The image processing apparatus according to claim 6, wherein the displaying unit displays information based on the printing setting information and the printing data upon input of the printing start instruction.

10. The image processing apparatus according to claim 6, wherein the displaying unit displays a list of the summaries of the printing setting information upon input of the printing start instruction.

11. An image processing apparatus for transmitting image data to a printing apparatus, comprising:
an intermediate data memory for memorizing printing data as reproducible intermediate data upon input of printing start instruction;
a displaying unit for displaying, when the printing data are completed, information based on printing setting information;
a timer for measuring time during displaying operation of the displaying unit;
a data converter for reproducing printing data from the reproducible intermediate data when the timer reaches a prescribed amount and for converting the printing data into printing controlling data based on the printing setting information; and
an interface unit for transmitting the printing controlling data to an image forming unit of the printing apparatus.

12. The image processing apparatus according to claim 11, further comprising a printing setting information changing inputting unit for receiving a change of the printing setting information until that the timer reaches the prescribed amount.

13. The image processing apparatus according to claim 11, wherein the displaying unit shows a transition that the timer reaches the prescribed amount.

14. The image processing apparatus according to claim 11, wherein the displaying unit displays information based on the printing setting information and the printing data upon input of the printing start instruction.

15. The image processing apparatus according to claim 11, wherein the displaying unit displays a list of the summaries of the printing setting information upon input of the printing start instruction.

16. An image forming system having an image processing apparatus and a printing apparatus for receiving image data from the image processing apparatus, the image forming system comprising:
a displaying unit for displaying, upon input of printing start instruction, information based on printing setting information;
a timer for measuring time during displaying operation of the displaying unit;
a data converter for converting printing data into printing controlling data based on the printing setting information at a time when the timer reaches a prescribed amount; and
an interface unit for transmitting the printing controlling data to an image forming unit of the printing apparatus.

17. The image forming system according to claim 16, further comprising a printing setting information changing inputting unit for receiving a change of the printing setting information until that the timer reaches the prescribed amount.

18. The image forming system according to claim 16, wherein the displaying unit shows a transition that the timer reaches the prescribed amount.

19. The image forming system according to claim 16, wherein the displaying unit displays information based on the printing setting information and the printing data upon input of the printing start instruction.

20. The image forming system according to claim 16, wherein the displaying unit displays a list of the summaries of the printing setting information upon input of the printing start instruction.
